(19) United States
(12) Patent Application Publication
(10) Pub. No.: US 2025/0246370 A1
(43) Pub. Date: Jul. 31, 2025

(54) MULTILAYER CERAMIC ELECTRONIC COMPONENT, AND METHOD OF MANUFACTURING THE SAME

(71) Applicant: TAIYO YUDEN CO., LTD.

(72) Inventors: Mika Nishizawa, Tokyo (JP); Kazuki Kawai, Tokyo (JP); Kenji Takashima, Tokyo (JP); Kazuho Murata, Tokyo (JP)

(21) Appl. No.: 19/024,454

(22) Filed: Jan. 16, 2025

(30) Foreign Application Priority Data
Jan. 30, 2024 (JP) 2024- 012162

(51) Int. Cl. H01G 4/12; H01G 4/30

(52) U.S. Cl. CPC H01G 4/1227; H01G 4/30

(57) ABSTRACT

A multilayer ceramic electronic component includes an element body including internal electrode layers and dielectric layers stacked alternately. Each of the dielectric layers includes core-shell grains each including a core portion, a first shell layer provided around the core portion, and a second shell layer provided around the first shell layer. The dielectric layer further includes a grain boundary between adjacent ones of the core-shell grains. Each of a concentration of a donor element in the first shell layer and a concentration of a donor element in the second shell layer is higher than a concentration of a donor element in the core portion.

### CROSS REFERENCE TO RELATED APPLICATIONS

This application claims priority benefit of Japanese Patent Application No. JP 2024-012162 filed in the Japan Patent Office on Jan. 30, 2024. Each of the above-referenced applications is hereby incorporated herein by reference in its entirety.

### BACKGROUND

The present disclosure relates to a multilayer ceramic electronic component and a method of manufacturing the same.

In recent years, there has been an increasing demand for reductions in size and increases in capacitance of multilayer ceramic electronic components such as multilayer ceramic capacitors. To meet such a demand, there has been a trend for materials that form dielectric layers to be increased in dielectric constant. In addition, there have been trends toward a reduction in thickness of dielectric layers and an increase in number of dielectric layers stacked. Reliability is also required of such dielectric layers. It is already known that a method of adding a specific element to raw material powder so as to form a solid solution in advance is effective, and a technique of adding a donor element in order to achieve an improvement in life characteristics has been proposed (see, for example, Japanese Patent Laid-open No. 2016-139720).

### SUMMARY

However, in recent years, which have seen reductions in thickness of dielectric layers and increases in number of dielectric layers stacked, there has been a demand for a further improvement in life characteristics.

Hence, it is desirable to improve life characteristics of dielectric layers.

A multilayer ceramic electronic component according to an embodiment of the present disclosure includes an element body including internal electrode layers and dielectric layers stacked alternately. Each of the dielectric layers includes core-shell grains each including a core portion, a first shell layer provided around the core portion, and a second shell layer provided around the first shell layer. The dielectric layer further includes a grain boundary between adjacent ones of the core-shell grains. Each of a concentration of a donor element in the first shell layer and a concentration of a donor element in the second shell layer is higher than a concentration of a donor element in the core portion.

In the above multilayer ceramic electronic component, the concentration of the donor element in the second shell layer may be higher than the concentration of the donor element in the first shell layer.

In the above multilayer ceramic electronic component, the concentration of the donor element in the second shell layer may be in a range of 0.1 to 3.0 at %, inclusive, when that of BaTiO₃ is assumed to be 100 at %.

In the above multilayer ceramic electronic component, the concentration of the donor element in the first shell layer may be in a range of 0.01 to 0.5 at %, inclusive, when that of BaTiO₃ is assumed to be 100 at %.

In the above multilayer ceramic electronic component, the second shell layer may contain at least one of a V element and an Mo element as the donor element.

In addition, in the above multilayer ceramic electronic component, the grain boundary may contain an Mn element.

Further, in the above multilayer ceramic electronic component, a concentration of the Mn element in the grain boundary may be in a range of 0.05 to 3.0 at %, inclusive, when that of BaTiO₃ is assumed to be 100 at %.

In the above multilayer ceramic electronic component, the core-shell grains may be present in the dielectric layer at a ratio ranging from 0.01 to 99 at %, inclusive.

In addition, in the above multilayer ceramic electronic component, the thickness of the second shell layer may be in a range of 0 nm, exclusive, to 12 nm, inclusive.

Further, in the above multilayer ceramic electronic component, the first shell layer may contain a rare-earth element and an Mg element.

A method of manufacturing a multilayer ceramic electronic component according to an embodiment of the present disclosure includes producing raw material powder including core-shell grains each including a core portion, a first shell layer provided around the core portion, and a second shell layer provided around the first shell layer, producing an element body that is substantially in a shape of a rectangular parallelepiped and that includes first internal electrode layers and second internal electrode layers stacked alternately with dielectric layers each including the raw material powder interposed therebetween, and subjecting the element body to firing.

In the above method, the producing the raw material powder may include a first-stage synthesis in which BaTiO₃ grains are coated with a rare-earth element and an Mg element and are subjected to firing, a second-stage synthesis in which the grains produced by the first-stage synthesis are coated with a donor element and are subjected to firing, and a third-stage synthesis in which an Mn element is added to the grains produced by the second-stage synthesis.

Further, the above method may further include coating the grains produced by the second-stage synthesis with a Yb element.

In the above method, the producing the raw material powder may involve addition of at least one of a Si element and a BN compound.

In the above method, the third-stage synthesis may involve addition of at least one of a Si element and a BN compound along with the Mn element.

In the above method, in the case where the Si element is added, the amount of the Si element added may be in a range of 0.5 to 3.0 at %, inclusive, when that of BaTiO₃ is assumed to be 100 at %.

In the above method, in the case where the BN compound is added, the amount of the BN compound added may be in a range of 0.1 to 2.0 at %, inclusive, when that of BaTiO₃ is assumed to be 100 at %.

In the above method, the raw material powder may contain, as a main component, a ceramic material having a perovskite structure represented by a general formula ABO₃, with A site containing at least Ba, and an A/B ratio being equal to or greater than 1.03 or equal to or smaller than 0.97. Note that the above perovskite structure includes ABO_{3-α} which deviates from a stoichiometric composition (0≤α≤1, where a denotes the amount of deviation from the stoichiometric composition).

In addition, in the above method, the subjecting the element body to firing may be subjecting the element body to pressure firing.

In the above method, the pressure firing may be performed at a temperature between 1150° C. and 1400° C., inclusive.

In the above method, the pressure firing may be performed at a pressure between 1 MPa and 7 MPa, inclusive.

According to the embodiments of the present disclosure, it is possible to achieve an improvement in life characteristics of dielectric layers.

### BRIEF DESCRIPTION OF THE DRAWINGS

FIG. 1 is a perspective view of a multilayer ceramic capacitor according to an embodiment of the present disclosure;

FIG. 2 is a sectional view of the multilayer ceramic capacitor taken along line A-A′ in FIG. 1;

FIG. 3 is a sectional view of the multilayer ceramic capacitor taken along line B-B′ in FIG. 1;

FIG. 4A is a schematic sectional view of a dielectric layer, and FIG. 4B is a schematic diagram illustrating grains that form the dielectric layer according to an embodiment of the present disclosure;

FIG. 5 is a schematic diagram illustrating a portion C in FIG. 4B;

FIG. 6 is a flowchart illustrating an example of a method of manufacturing the multilayer ceramic capacitor according to an embodiment of the present disclosure;

FIG. 7 is a flowchart illustrating an example of synthesis steps included in a raw material powder production step;

FIG. 8 is a schematic diagram illustrating a process by which a ceramic sheet is obtained, starting with a first-stage synthesis;

FIG. 9 is a graph illustrating a relation between the concentration of Mn in a grain boundary and the life; and

FIG. 10 is a graph illustrating a relation between the concentration of V in a second shell layer and the life.

### DETAILED DESCRIPTION OF THE PREFERRED EMBODIMENTS

Hereinafter, embodiments of the present disclosure will be described with reference to the accompanying drawings. In the accompanying drawings, an X-axis, a Y-axis, and a Z-axis, which are perpendicular to one another, are depicted as appropriate. The X-axis, the Y-axis, and the Z-axis are common to all of the drawings. An X-axis direction corresponds to a second direction, a Y-axis direction corresponds to a third direction, and a Z-axis direction corresponds to a first direction.

### [Overall Configuration of Multilayer Ceramic Capacitor 10]

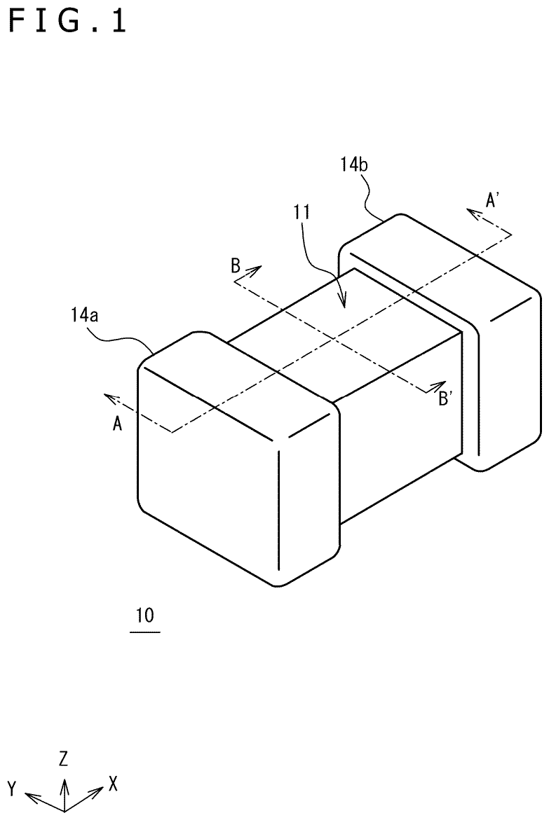

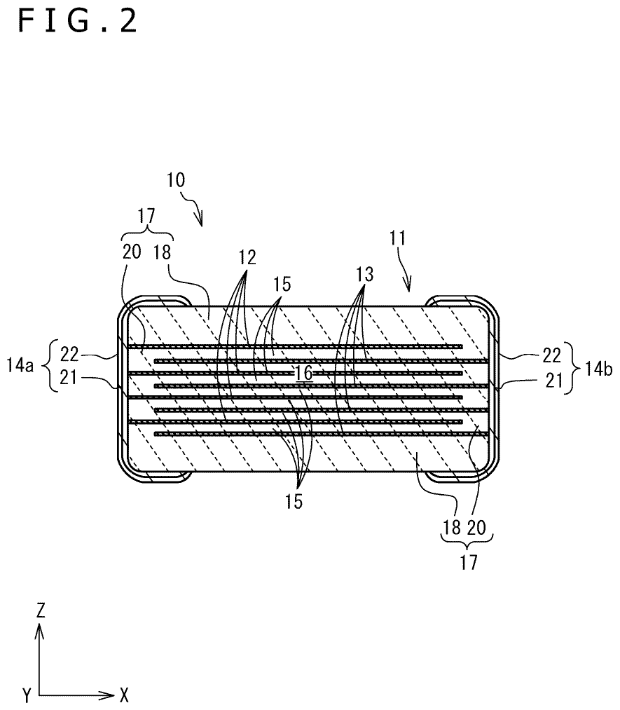

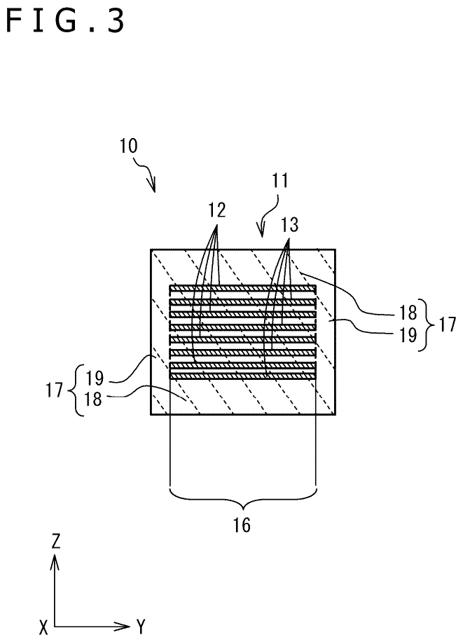

FIGS. 1, 2, and 3 are each a diagram illustrating one example of a multilayer ceramic capacitor 10 according to a first embodiment of the present disclosure. FIG. 1 is a perspective view of the multilayer ceramic capacitor 10. FIG. 2 is a sectional view of the multilayer ceramic capacitor 10 taken along line A-A′ in FIG. 1. FIG. 3 is a sectional view of the multilayer ceramic capacitor 10 taken along line B-B′ in FIG. 1.

The multilayer ceramic capacitor 10 includes a ceramic element body 11 as an element body substantially in the shape of a rectangular parallelepiped. The ceramic element body 11 includes six surfaces that substantially form a rectangular parallelepiped, and of the six surfaces, principal surfaces facing each other will be referred to as an upper surface and a lower surface, and four surfaces other than the upper surface and the lower surface will be referred to as side surfaces. In general, the term “principal surface” refers to a surface that has the greatest area. A first external electrode 14a and a second external electrode 14b are provided on external surfaces of the ceramic element body 11 such that the first external electrode 14a and the second external electrode 14b are apart from each other. In the example of FIGS. 1 to 3, the first external electrode 14a and the second external electrode 14b are provided on two side surfaces (i.e., a first side surface and a second side surface) facing each other. The first external electrode 14a extends from the first side surface onto four adjacent surfaces. The second external electrode 14b extends from the second side surface onto the four adjacent surfaces. Note, however, that the first external electrode 14a and the second external electrode 14b are apart from each other.

The first external electrode 14a and the second external electrode 14b may be provided at any desired positions on the external surfaces of the ceramic element body 11 as long as the first external electrode 14a and the second external electrode 14b are apart from each other. For example, the first external electrode 14a and the second external electrode 14b may be provided, apart from each other, on the same surface out of the external surfaces of the ceramic element body 11, or alternatively, the first external electrode 14a and the second external electrode 14b may be provided, apart from each other, on two adjacent or facing surfaces of the ceramic element body 11.

As long as the first external electrode 14a and the second external electrode 14b are apart from each other, each of the first external electrode 14a and the second external electrode 14b may extend from one surface of the ceramic element body 11 on which the first or second external electrode 14a or 14b is provided, onto any other desired surface or surfaces. For example, each of the first external electrode 14a and the second external electrode 14b may extend from the one surface onto a surface adjacent thereto, and may further extend therefrom to another surface.

Note that a multilayer ceramic component has a first direction, which corresponds to a stack direction, a second direction, which is perpendicular to the stack direction and in which two facing surfaces intersect, and a third direction, which is perpendicular to each of the first and second directions and in which two facing surfaces intersect. The first direction, the second direction, and the third direction are perpendicular to one another. Any of the longitudinal direction, width direction, and heightwise direction of the ceramic element body 11 may be set as the stack direction.

In FIGS. 1 to 3, the stack direction, i.e., the first direction, is the Z-axis direction, is the heightwise direction of the ceramic element body 11, and is a direction in which internal electrode layers face one another. In FIGS. 1 to 3, the second direction, which is perpendicular to the stack direction, is the X-axis direction, is the longitudinal direction of the ceramic element body 11, is a direction in which the first side surface and the second side surface of the ceramic element body 11 face each other, and is a direction in which the first external electrode 14a and the second external electrode 14b face each other. In FIGS. 1 to 3, the third direction, which is perpendicular to each of the stack direction (i.e., the first direction) and the second direction, is the Y-axis direction, is the width direction of the internal electrode layers, and is a direction in which, out of the four side surfaces of the ceramic element body 11, two side surfaces (i.e., a third side surface and a fourth side surface) other than the first side surface and the second side surface face each other. The X-axis direction, the Y-axis direction, and the Z-axis direction are perpendicular to one another.

The ceramic element body 11 has a configuration in which dielectric layers 15, each including a ceramic material that functions as a dielectric, and the internal electrode layers are stacked alternately. The internal electrode layers include a plurality of first internal electrode layers 12 and a plurality of second internal electrode layers 13. The first internal electrode layers 12 and the second internal electrode layers 13 are stacked alternately. Edges of the first internal electrode layers 12 are led out to the external surface of the ceramic element body 11 on which the first external electrode 14a is provided. Edges of the second internal electrode layers 13 are led out to the external surface of the ceramic element body 11 on which the second external electrode 14b is provided. Note that it is sufficient if the first internal electrode layers 12 and the second internal electrode layers 13 are exposed to different regions of the external surfaces of the stacked body to be in electrical continuity with different external electrodes. Such different regions of the external surfaces of the stacked body may be external surface regions on facing surfaces of the stacked body, external surface regions on adjacent surfaces of the stacked body, or different external surface regions on the same surface of the stacked body. As long as the different external electrodes are apart from each other, each of the different external electrodes may extend, onto another surface, from the surface on which corresponding ones of the first internal electrode layers 12 and the second internal electrode layers 13 are exposed to the corresponding external surface region of the stacked body. In the example of FIGS. 1 to 3, the edges of the first internal electrode layers 12 are led out to the first side surface, on which the first external electrode 14a is provided, of the ceramic element body 11. The edges of the second internal electrode layers 13 are led out to the second side surface, on which the second external electrode 14b is provided, of the ceramic element body 11.

Thus, the first internal electrode layers 12 are in electrical continuity with the first external electrode 14a, and the second internal electrode layers 13 are in electrical continuity with the second external electrode 14b. As a result, the multilayer ceramic capacitor 10 has a configuration in which capacitor units are stacked, that is, a capacitance forming portion 16. In addition, in the stacked body including the dielectric layers 15 and the internal electrode layers, internal electrode layers are arranged in outermost layers in the stack direction, and each of an upper surface and a lower surface of the stacked body is covered with a cover portion 18. The cover portion 18 includes a ceramic material as a main component.

The multilayer ceramic capacitor 10 may have, for example, any of the following sizes but is not limited to the following sizes: a length of 0.25 mm, a width of 0.125 mm, and a height of 0.125 mm; a length of 0.4 mm, a width of 0.2 mm, and a height of 0.2 mm; a length of 0.6 mm, a width of 0.3 mm, and a height of 0.3 mm; a length of 1.0 mm, a width of 0.5 mm, and a height of 0.5 mm; a length of 3.2 mm, a width of 1.6 mm, and a height of 1.6 mm; and a length of 4.5 mm, a width of 3.2 mm, and a height of 2.5 mm. The size of the multilayer ceramic capacitor 10 may be, for example, as follows: length>width≥height, width>length≥height, height>length≥width, or height>width≥length.

The ceramic element body 11 includes a protective portion 17 and the capacitance forming portion 16 which is the stacked body including the dielectric layers 15, the first internal electrode layers 12, and the second internal electrode layers 13. The protective portion 17 forms a peripheral portion of the ceramic element body 11, and has two end surfaces facing in the X-axis direction, two side surfaces facing in the Y-axis direction, and two principal surfaces facing in the Z-axis direction. The side surfaces and the principal surfaces form a plurality of peripheral surfaces. Each of the end surfaces, the side surfaces, and the principal surfaces is formed by, for example, a substantially flat surface, but may be rounded.

The protective portion 17 includes the cover portions 18, side margin portions 19, and end margin portions 20. The cover portions 18 are positioned outside of the capacitance forming portion 16 in the stack direction, i.e., positioned outside of the capacitance forming portion 16 in the Z-axis direction in the example of FIGS. 1 to 3. The side margin portions 19 are provided outside of the capacitance forming portion 16 in a direction perpendicular to the stack direction. The side margin portions 19 are provided as regions not including respective edge portions of the first internal electrode layers 12 and the second internal electrode layers 13 led out to the external surfaces of the ceramic element body 11 in a direction perpendicular to the stack direction. That is, in the example of FIGS. 1 to 3, the side margin portions 19 are positioned outside of the capacitance forming portion 16 in the Y-axis direction. The end margin portions 20 are provided outside of the capacitance forming portion 16 in a direction perpendicular to the stack direction. The end margin portions 20 are provided as regions including the respective edge portions of the first internal electrode layers 12 and the second internal electrode layers 13 led out to the external surfaces of the ceramic element body 11 in a direction perpendicular to the stack direction. That is, in the example of FIGS. 1 to 3, the end margin portions 20 are positioned outside of the capacitance forming portion 16 in the X-axis direction.

Each side margin portion 19 is a region made up of only dielectric layers. Each end margin portion 20 is a region including dielectric layers and the edge portions of the first internal electrode layers 12 or the second internal electrode layers 13 led out to the external surface of the ceramic element body 11.

The capacitance forming portion 16 is arranged inside of the protective portion 17 and forms a functional portion. The capacitance forming portion 16 has the plurality of first internal electrode layers 12 and the plurality of second internal electrode layers 13 stacked with the dielectric layers 15 (see FIG. 2) interposed therebetween. In the example of FIGS. 1 to 3, the first and second internal electrode layers 12 and 13 are stacked in the Z-axis direction. The internal electrode layers 12 and 13 are each in the shape of a sheet extending along a plane perpendicular to the stack direction, and are arranged alternately in the stack direction. In the example of FIGS. 1 to 3, the internal electrode layers 12 and 13 are each in the shape of a sheet extending along an X-Y plane, and are arranged alternately in the Z-axis direction. The configuration of the dielectric layers 15 will be described in detail below.

Each of the first internal electrode layers 12 and the second internal electrode layers 13 includes, as a main component, base metal, such as nickel (Ni), copper (Cu), or tin (Sn), or an alloy including such base metal. As the main component of each of the first internal electrode layers 12 and the second internal electrode layers 13, precious metal, such as platinum (Pt), palladium (Pd), silver (Ag), or gold (Au), or an alloy including such precious metal may be used. The main component of each of the first internal electrode layers 12 may be either the same as or different from the main component of each of the second internal electrode layers 13.

The dielectric layers 15 have, as a main phase, a ceramic material having a perovskite structure represented by the general formula ABO₃, for example. The A/B ratio is equal to or greater than 1.03 or equal to or smaller than 0.97. Note that the above perovskite structure includes ABO_{3-α} which deviates from a stoichiometric composition (0≤α≤1, where a denotes the amount of deviation from the stoichiometric composition; hereinafter, α will be omitted). As the above ceramic material, at least one material selected from the following group, for example, can be used: barium titanate (BaTiO₃), calcium zirconate (CaZrO₃), calcium titanate (CaTio₃), strontium titanate (SrTiO₃), magnesium titanate (MgTiO₃), Ba_{1-x-y}CaₓSr_{y}Ti_{1-z}Zr_{z}O₃ forming the perovskite structure (0≤x≤1, 0≤y≤1, 0≤z≤1), and other similar materials. Examples of Ba_{1-x-y}CaₓSr_{y}Ti_{1-z}Zr₂O₃ include barium strontium titanate, barium calcium titanate, barium zirconate, barium titanate zirconate, calcium titanate zirconate, and barium calcium titanate zirconate. For example, in each dielectric layer 15, the main component ceramic is contained in an amount of 50 at % or more, e.g., 90 at % or more. The thickness of the dielectric layer 15 is, for example, 5.0 μm or less, 3.0 μm or less, 1.0 μm or less, 0.5 μm or less, 0.4 μm or less, 0.3 μm or less, or 0.2 μm or less. The thickness of the dielectric layer 15 can be measured by observing a section of the multilayer ceramic capacitor 10 with use of a scanning electron microscope (SEM), measuring the thickness at ten points with respect to each of ten different ones of the dielectric layers 15, and deriving an average of values obtained at all measurement points. Any of the dielectric ceramics listed above can be a main component of the dielectric layers 15.

An additive may be added to the dielectric layers 15. Examples of additives that can be added to the dielectric layers 15 include zirconium (Zr), magnesium (Mg), manganese (Mn), molybdenum (Mo), vanadium (V), chromium (Cr), oxides of rare-earth elements (scandium (Sc), cerium (Ce), neodymium (Nd), yttrium (Y), samarium (Sm), europium (Eu), gadolinium (Gd), terbium (Tb), dysprosium (Dy), holmium (Ho), erbium (Er), thulium (Tm), and ytterbium (Yb)), oxides containing cobalt (Co), nickel (Ni), lithium (Li), boron (B), sodium (Na), potassium (K), or silicon (Si), and glass containing cobalt, nickel, lithium, boron, boron nitride (BN), sodium, potassium, or silicon.

The protective portion 17 is also formed of a dielectric ceramic. It is preferable that the cover portions 18 and the end margin portions 20 of the protective portion 17 have the same composition as the main component with the dielectric layers 15 from the viewpoint of, for example, reducing internal stress. In addition, this will lead to improved manufacturing efficiency.

Each of the external electrodes 14a and 14b includes a base film 21 so formed as to cover led-out portions of the internal electrode layers 12 or 13 and portions of the external surfaces of the ceramic element body 11, and a plating film 22 formed on the base film 21. The base film 21 is formed by, for example, a sintered film obtained by subjecting an electrically conductive paste to firing, a sputtered film, or another film. The plating film 22 is a film formed by electroplating. Each film of the external electrodes 14a and 14b is formed of, for example, metal or an alloy that contains, as a main component, nickel (Ni), copper (Cu), tin (Sn), palladium (Pd), platinum (Pt), silver (Ag), gold (Au), aluminum (Al), or another material. In addition, each of the external electrodes 14a and 14b may be formed by printing and drying of a curable resin-containing electrically conductive paste containing one selected from several kinds of resins and one selected from several kinds of electrically conductive metals, e.g., resin Ag.

### [Detailed Configuration of Dielectric Layer 15]

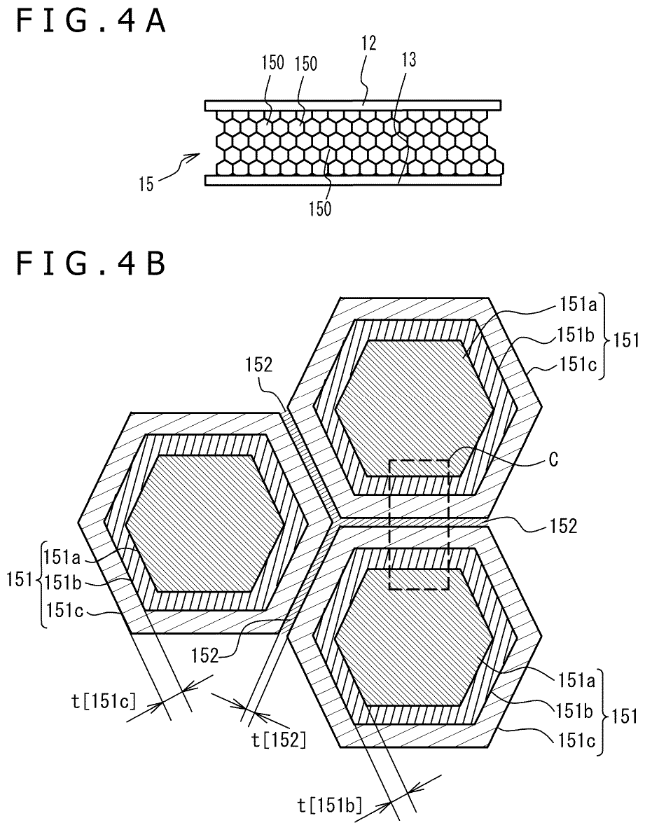

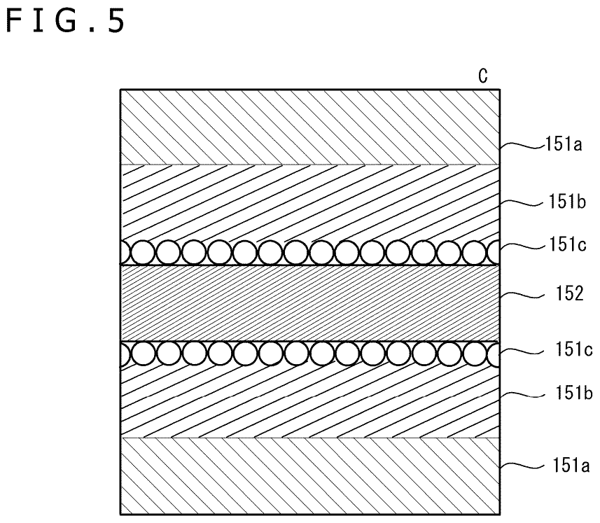

FIG. 4A is a schematic sectional view of the dielectric layer 15, and FIG. 4B is a schematic diagram illustrating grains 151 that form the dielectric layer 15 according to an embodiment of the present disclosure. FIG. 5 is a schematic diagram illustrating a portion C in FIG. 4B. As illustrated in FIG. 4A, the dielectric layer 15 includes a plurality of crystal grains 150 of the main component ceramic. At least some of these crystal grains 150 are core-shell grains 151 illustrated in FIG. 4B.

Each core-shell grain 151 includes a core portion 151a positioned in the center of the grain, a first shell layer 151b provided around the core portion 151a, and a second shell layer 151c provided around the first shell layer 151b. A grain boundary 152 is formed between adjacent ones of the core-shell grains 151. It is sufficient if the core-shell grains 151 are at least included in the dielectric layer 15. That is, it is sufficient if the core-shell grains 151 are present in the dielectric layer 15 at a ratio ranging from 0.01 to 99 at %, inclusive, but it is desirable that the core-shell grains 151 be present in the dielectric layer 15 at a ratio ranging from 20 to 99 at %, inclusive.

The core portion 151a contains the dielectric ceramic that is the main component of the dielectric layer 15.

The first shell layer 151b contains a holmium (Ho) element as a rare-earth element, and an Mg element. Here, an effect of containing the Ho element and the Mg element in the first shell layer 151b will briefly be described along with an outline of the mechanism thereof.

Ho is a trivalent element, and, as indicated by eq. 1 below, acts as a donor when incorporated into a Ba (2+) site of BaTiO₃ so as to form a substitutional solid solution. In addition, electrons generated in the reaction indicated by eq. 1 cause a leftward reaction indicated by eq. 2, which is an equation related to oxide ion vacancies, so as to reduce oxide ion vacancies.

$${Ho}_{2} {O}_{32 ( BaO )} \to 2 {H}_{{O}_{Ba}} + 2 {O}_{O}^{\times } + \frac{1}{2} {O}_{2} + 2 {e}^{-} \qquad eq . 1$$

$${O}_{O}^{\times } ⇌ \frac{1}{2} {O}_{2} + {V}_{O}^{..} + 2 {e}^{-} \qquad eq . 2$$

The oxide ion vacancies can be considered to cause a reduction in the life of the multilayer ceramic capacitor 10. Therefore, the addition of the Ho element, which leads to reducing the oxide ion vacancies, can be considered to suppress the reduction in the life of the multilayer ceramic capacitor 10.

Mg is a bivalent element, and acts as an acceptor when incorporated into a Ti (4+) site in the perovskite structure of BaTiO₃ so as to form a substitutional solid solution. This reaction occurs prior to the reaction in which the Ho element is involved. The incorporation of the Mg element distorts a lattice of BaTiO₃, making the incorporation of the Ho element easier. In view of this point, in the present embodiment, the Mg element is added to make the incorporation of the Ho element easier. Moreover, when Ho (3+) is incorporated into the Ba (2+) site, the difference in electric charge is −1, whereas, when Mg (2+) is incorporated into the Ti (4+) site, the difference in electric charge is +2. Therefore, the addition and incorporation of the Mg element can be considered to exhibit an effect of electric charge compensation as well.

Examples of other rare-earth elements that can be adopted, other than the Ho element, include yttrium (Y), cerium (Ce), neodymium (Nd), lanthanum (La), samarium (Sm), europium (Eu), gadolinium (Gd), terbium (Tb), and dysprosium (Dy).

The second shell layer 151c contains a V element. The second shell layer 151c may contain an Mo element instead of the V element. The V element and the Mo element are examples of donor elements. A donor element is an element that functions as a donor at a B site. The V element and the Mo element tend to easily segregate in the vicinity of the grain boundary 152, and thus tend to easily form the second shell layer 151c. The V element and the Mo element can be considered to perform a function of reducing oxide ion vacancies in the vicinity of the grain boundary 152. In the case where the V element is adopted as a donor element, electrons are generated as indicated by eq. 3 below. The generated electrons cause a leftward reaction indicated by eq. 4 below.

$${V}_{2} {O}_{5 ( 2 {TiO}_{2} )} \to 2 {V}_{Ti}^{.} + 4 {O}_{O}^{\times } + \frac{1}{2} {O}_{2} + 2 {e}^{-} \qquad eq . 3$$

$${O}_{O}^{\times } \to {V}_{O}^{..} + \frac{1}{2} {O}_{2} + 2 {e}^{-} \qquad eq . 4$$

The V element has a variable valence, but can basically be incorporated into the Ti site to function as a donor element, generating mobile electrons as indicated by eq. 3 above. The mobile electrons cause a leftward reaction indicated by eq. 4 above, which is an equation related to generation of oxide ion vacancies, so as to reduce the oxide ion vacancies. As mentioned above, the oxide ion vacancies are considered to cause a reduction in the life of the multilayer ceramic capacitor 10. Therefore, the addition of the V element, which is capable of functioning as a donor element, leads to reducing the oxide ion vacancies, and can be considered to suppress the reduction in the life of the multilayer ceramic capacitor 10.

Here, the concentration of the donor element in the second shell layer 151c may be in the range of 0.1 to 3.0 at %, inclusive, when that of BaTiO₃ is assumed to be 100 at %. The concentration of the donor element is a concentration relative to the main component ceramic, i.e., a concentration relative to BaTiO₃.

The donor element may be contained in the first shell layer 151b. In this case, the concentration of the donor element in the first shell layer 151b may be in the range of 0.01 to 0.5 at %, inclusive, when that of BaTiO₃ is assumed to be 100 at %. The concentration of the donor element in this case is also a concentration relative to the main component ceramic, i.e., a concentration relative to BaTiO₃.

As described above, in the multilayer ceramic capacitor 10 according to the present embodiment, the concentration of the donor element in the second shell layer 151c is higher than the concentration of the donor element in the first shell layer 151b. In addition, each of the concentration of the donor element in the first shell layer 151b and the concentration of the donor element in the second shell layer 151c is higher than the concentration of the donor element in the core portion 151a.

The grain boundary 152 contains an Mn element. Containing the Mn element in the grain boundary 152 makes it easier for a vicinity of the grain boundary 152 to be charged with positive (+) electric charge, producing a situation that appears as if a Schottky barrier had been formed between the grain boundary 152 and the second shell layer 151c. The oxide ion vacancies repulse the grain boundary 152 in such a situation. As a result, the oxide ion vacancies are unable to move across the grain boundary 152 and are thus restrained from moving between adjacent ones of the core-shell grains 151. This leads to an improved reliability of the dielectric layer 15.

With reference to FIG. 4B, the thickness of the first shell layer 151b is t [151b]. An appropriate value in the range of 1 nm to 100 nm, inclusive, can be set as the thickness t [151b]. The thickness of the second shell layer 151c is t [151c]. An appropriate value in the range of 0 nm, exclusive, to 12 nm, inclusive, can be set as the thickness t [151c]. Further, the thickness of the grain boundary 152 is t. An appropriate value in the range of 0.1 to 5 nm, inclusive, can be set as the thickness t.

The concentration of the V element as the donor element in the second shell layer 151c may be in the range of 0.01% to 0.5%, inclusive. Here, the concentration of the V element is a concentration in terms of atomic percentage (at %) relative to barium titanate (BaTiO₃) that forms the core portion 151a. Note that, in the case where the Mo element is used in place of the V element, the concentration of the Mo element may be in the range of 0.01% to 0.5%, inclusive.

The concentration of the Mn element in the grain boundary 152 may be in the range of 0.05 to 3.0 at %, inclusive, more preferably, in the range of 0.1 to 3.0 at %, inclusive, when that of BaTiO₃ is assumed to be 100 at %. The concentration of the Mn element is a concentration in terms of atomic percentage (at %) relative to barium titanate (BaTiO₃) that forms the core portion 151a.

The core-shell grains 151 can be observed by, for example, mapping elements to be measured, by use of a combination of transmission electron microscopy and energy dispersive X-ray spectroscopy (TEM-EDS). The thickness of each of the layers included in the core-shell grain 151 may be measured using a sectional image captured by an SEM.

The thickness t [151b] of the first shell layer 151b, the thickness t [151c] of the second shell layer 151c, and the thickness t of the grain boundary 152 can be measured on the basis of measurement results of the TEM-EDS. In addition, the concentration of the V element, the concentration of the Mo element, and the concentration of the Mn element can be measured on the basis of measurement results of the TEM-EDS.

### [Method of Manufacturing Multilayer Ceramic Capacitor 10]

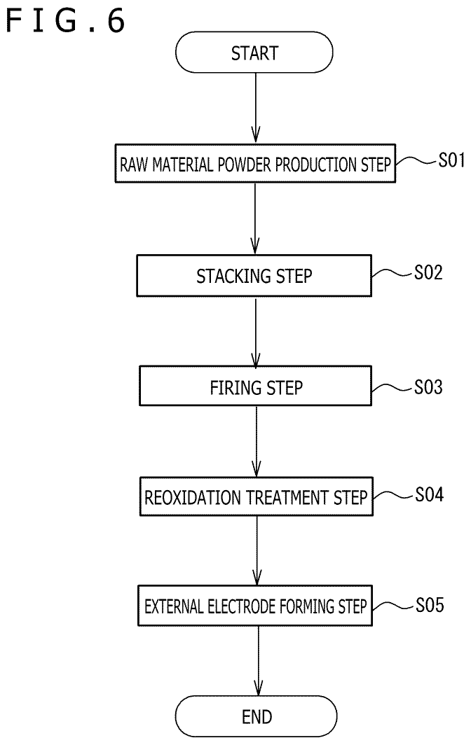

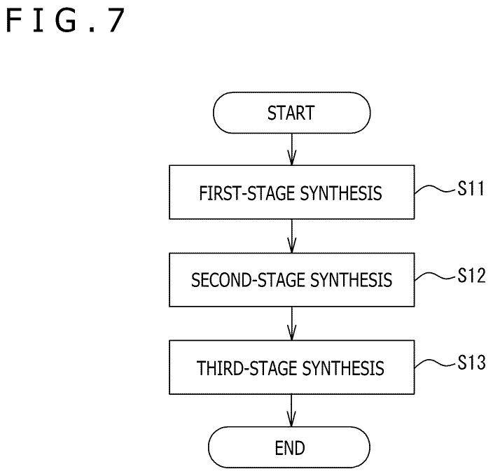

Next, a method of manufacturing the multilayer ceramic capacitor 10 will be described below. FIG. 6 is a diagram illustrating an example of a flow of the method of manufacturing the multilayer ceramic capacitor 10. A raw material powder production step at step S01 includes a first-stage synthesis (step S11), a second-stage synthesis (step S12), and a third-stage synthesis (step S13) illustrated in FIG. 7.

### (Step S01: Raw Material Powder Production Step)

A dielectric material for forming the dielectric layers 15 is prepared. The dielectric material is prepared prior to production of multilayer ceramic chips C. A and B site elements contained in each dielectric layer 15 are typically contained in the dielectric layer 15 in the form of a sintered body of grains of ABO₃. For example, barium titanate is a tetragonal compound having the perovskite structure, and exhibits a high relative dielectric constant. This barium titanate can typically be obtained by causing a titanium material, such as titanium dioxide, to react with a barium material, such as barium carbonate, to synthesize barium titanate. As methods for synthesizing the main component ceramic of the dielectric layers 15, a variety of methods have been known, including, for example, a solid phase method, a sol-gel method, and a hydrothermal method. In the present embodiment, any of these methods can be adopted.

A predetermined additive compound that suits an intended purpose is added to ceramic raw material powder obtained. Examples of such additive compounds include zirconium (Zr), magnesium (Mg), manganese (Mn), molybdenum (Mo), vanadium (V), chromium (Cr), oxides of rare-earth elements (scandium (Sc), cerium (Ce), neodymium (Nd), yttrium (Y), samarium (Sm), europium (Eu), gadolinium (Gd), terbium (Tb), dysprosium (Dy), holmium (Ho), erbium (Er), thulium (Tm), and ytterbium (Yb)), oxides containing cobalt (Co), nickel (Ni), lithium (Li), boron (B), sodium (Na), potassium (K), or silicon (Si), and glass containing cobalt, nickel, lithium, boron, sodium, potassium, or silicon.

For example, compounds containing the additive compound are wet-mixed into the ceramic raw material powder, and the resulting mixture is dried and pulverized to prepare a ceramic material. For example, the ceramic material obtained in the above-described manner may be subjected to a pulverization process as needed to adjust grain sizes thereof, or a classification process may be performed in combination to equalize the grain sizes. As a result of the above processes, the dielectric material is obtained. The obtained dielectric material is used to form, primarily, the core portion 151a.

### <<Step S11: First-Stage Synthesis>>

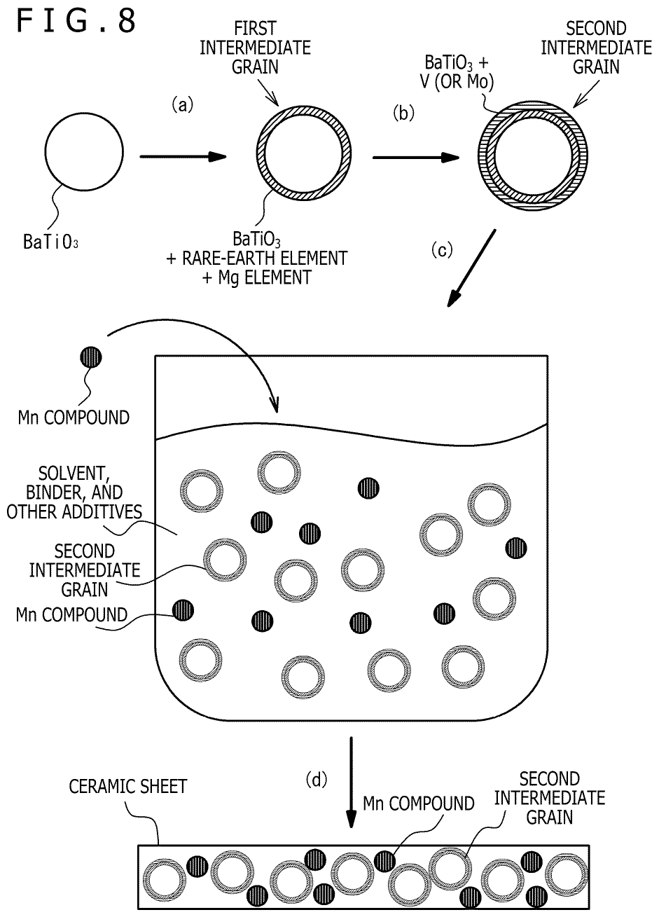

The obtained dielectric material is coated with at least magnesium (Mg) and holmium (Ho) which is a rare-earth element, and the resultant is subjected to firing (see (a) in FIG. 8). This produces first intermediate grains each having BaTiO₃ that forms the core portion 151a, and having formed therearound a layer that forms the first shell layer 151b and which contains the Ho element and the Mg element in addition to BaTiO₃ as a main component. Here, the firing is performed under conditions of atmospheric pressure and a temperature between 900° C. and 1000° C., inclusive, for a period of one to four hours, inclusive. Note that the above coating may be performed by, for example, a coprecipitation method, but any other desired known method can alternatively be adopted therefor.

### <<Step S12: Second-Stage Synthesis>>

The first intermediate grains obtained by the first-stage synthesis are each coated with the V element as a donor element, and the resultant is subjected to firing (see (b) in FIG. 8). This produces second intermediate grains each having the first intermediate grain obtained by the first-stage synthesis, and having formed therearound a layer that forms the second shell layer 151c and which includes the V element in addition to BaTiO₃. Note that each of the first intermediate grains may be coated with the Mo element instead of the V element. Here, the firing is performed under conditions of atmospheric pressure and a temperature between 900° C. and 1000° C., inclusive, for a period of one to four hours, inclusive. Note that the above coating may be performed by, for example, the coprecipitation method, but any other desired known method can alternatively be adopted therefor.

### <<Step S13: Third-Stage Synthesis>>

At least the Mn element, a binder, such as polyvinyl butyral (PVB) resin, an organic solvent, such as ethanol or toluene, and a plasticizer are added to and wet-mixed with the second intermediate grains obtained by the second-stage synthesis to obtain a slurry (see (c) in FIG. 8). In the present embodiment, the Mn element is added in the form of a Mn compound. When the slurry is obtained, other predetermined additive compounds that suit intended purposes may be added. Examples of such additive compounds include niobium (Nb), tantalum (Ta), tungsten (W), chromium (Cr), oxides of rare-earth elements (yttrium (Y), samarium (Sm), europium (Eu), gadolinium (Gd), terbium (Tb), dysprosium (Dy), and thulium (Tm)), cobalt (Co), nickel (Ni), lithium (Li), boron (B), sodium (Na), and potassium (K). In addition, in the third-stage synthesis, an element selected from Ba, Ti, Zr, and other similar materials, which are constituent elements of the main component of the dielectric material, may be added as appropriate.

Note that, after the second-stage synthesis, the second intermediate grains may be coated with, for example, an ytterbium (Yb) element. The coating of the Yb element contributes to preventing a mixture of the second shell layer 151c and the grain boundary 152 in a firing step (step S3), which will be described below. Note that the second intermediate grains may alternatively be coated with an erbium (Er) element instead of the Yb element.

In addition, a Si element and a boron nitride (BN) compound may be added, for example, in an amount of 2 at % or more to reduce the firing temperature in the firing step (step S3). The addition of the Si element and the BN compound may be performed when the third-stage synthesis is performed, that is, simultaneously with the addition of the Mn compound as indicated by (c) in FIG. 8. The reduced firing temperature leads to reduced diffusion of the elements, and contributes to preventing a mixture of the first shell layer 151b, the second shell layer 151c, and the grain boundary 152. This phenomenon is thought to be due to a reduction in diffusion coefficient caused by the reduced firing temperature, but a detailed explanation thereof is omitted. Note that it is sufficient if at least one of the Si element and the BN compound is added. This is because a reduction in sintering temperature can presumably be achieved either by addition of both the Si element and the BN compound or by addition of one of the Si element and the BN compound. In the case where the Si element is added, the amount of the Si element added may be in the range of 0.5 to 3.0 at %, inclusive. In the case where the BN compound is added, the amount of the BN compound added may be in the range of 0.1 to 2.0 at %, inclusive.

### (Step S02: Stacking Step)

Next, a binder, such as polyvinyl butyral (PVB) resin, an organic solvent, such as ethanol or toluene, and a plasticizer are added to and wet-mixed with the dielectric material obtained by the third-stage synthesis. Using the resulting slurry, a dielectric green sheet (i.e., a ceramic sheet) is formed on a base by, for example, a die coater method or a doctor blade method, and the dielectric green sheet is dried (see (d) in FIG. 8).

Next, a metal conductive paste for forming internal electrodes containing an organic binder is printed on a surface of the dielectric green sheet through screen printing, gravure printing, or another kind of printing, so that a pattern for an internal electrode layer is arranged thereon. Ceramic grains may or may not be added to the metal conductive paste as additive materials. In the case where ceramic grains are added thereto as additive materials, it is preferable that a main component of the ceramic grains be the same as the main component ceramic of the dielectric layers 15, although this is not essential to the present disclosure.

Thereafter, dielectric green sheets, separated from the base, are stacked alternately such that the internal electrode layers 12 and 13 alternate with the dielectric layers 15 and that the internal electrode layers 12 and 13 have edges alternately exposed at end surfaces of the dielectric layers 15 on both sides in the longitudinal direction to be alternately led out to the external electrodes 14a and 14b which are paired with each other and different in polarity. For example, a total of 100 to 500 layers of dielectric green sheets are stacked. Thereafter, a plurality of cover sheets, which are to form the cover portion 18, are pressure-bonded to each of a top and a bottom of a stacked body including the stacked dielectric green sheets, resulting in a ceramic stacked body. Thereafter, the obtained ceramic stacked body is cut into individual pieces each having predetermined chip dimensions (e.g., chip dimensions adjusted with shrinkage due to firing taken into consideration when the dimensions of the multilayer ceramic capacitor 10 are 0.6 mm×0.3 mm×0.3 mm).

### (Step S03: Firing Step)

At step S03, an element body with pre-firing ceramic obtained by step S02 is subjected to firing to produce the ceramic element body 11 of the multilayer ceramic capacitor 10 as illustrated in FIG. 1. The firing temperature in step S03 may be determined on the basis of the sintering temperature of the pre-firing ceramic element body. In addition, the firing may be performed employing a method known in the art, for example, in a reducing atmosphere or in an atmosphere with a low oxygen partial pressure. The firing may be performed, for example, in a reducing atmosphere with an oxygen partial pressure of 10-5 to 10-8 atm and at a firing temperature of 1100° C. to 1300° C. for a period of ten minutes to two hours.

In the present embodiment, pressure firing may be adopted. Specifically, the firing in the present embodiment is performed at a temperature between 1150° C. and 1400° C., inclusive, and at a pressure between 1 MPa and 7 MPa, inclusive. Increased pressure during the firing is expected to produce an effect of suppressing grain growth of BaTiO₃ grains, and preventing a mixture of elements between the first shell layer 151b, the second shell layer 151c, and the grain boundary 152. Note that, in the firing step, a stacked body obtained in the above-described manner may, for example, be subjected to a binder removing process in an N₂ atmosphere, and then to application of a metal paste that is to form bases of the external electrodes 14a and 14b by using a dip method, and be fired in a reducing atmosphere with an oxygen partial pressure of 10-5 to 10-8 atm at a firing temperature of 1100° C. to 1300° C. for a period of ten minutes to two hours.

### (Step S04: Reoxidation Treatment Step)

Thereafter, reoxidation treatment may be performed in an N₂ gas atmosphere at a temperature of 600° C. to 1000° C.

### (Step S05: External Electrode Forming Step)

Thereafter, the base films 21 are formed. To form the base films 21, a pre-firing electrode material is applied to end surfaces 11a, side surfaces 11b, and principal surfaces 11c of the ceramic element body 11. A method for this application is, for example, a dip method, but any of other methods known in the art, such as a printing method and a sputtering method, or a combination of such methods may alternatively be adopted. Then, the pre-firing electrode material is subjected to sintering. The sintering may be performed, for example, in a reducing atmosphere or in an atmosphere with a low oxygen partial pressure. After the base films 21 are formed, the ceramic element body 11 with the base films 21 is immersed in a plating solution for forming the plating films 22 to perform electroplating. As a result, the plating films 22 are formed, completing formation of the external electrodes 14a and 14b.

While embodiments of the present disclosure have been described above, the present disclosure is not limited to the above-described embodiments, and it is to be appreciated that various modifications may be made without departing from the gist of the present disclosure.

The multilayer ceramic capacitor 10 as illustrated in FIGS. 1 to 3 is manufactured in the above-described manner.

The multilayer ceramic capacitor 10 according to the present embodiment includes the dielectric layers 15. The dielectric layers 15 each include the core-shell grains 151 each including the core portion 151a, the first shell layer 151b provided around the core portion 151a, and the second shell layer 151c provided around the first shell layer 151b. In addition, the grain boundary 152 is provided between adjacent ones of the core-shell grains 151. This leads to improved life characteristics of the dielectric layers 15.

In the multilayer ceramic capacitor 10, the second shell layer 151c contains the V element or the Mo element, which acts as a donor element, and this leads to an effective improvement in the life characteristics of the dielectric layers 15.

In the multilayer ceramic capacitor 10, the grain boundary 152 contains the Mn element, and this leads to an effective improvement in the life characteristics of the dielectric layers 15.

While embodiments of the present disclosure have been described above, the present disclosure is not limited to the above-described embodiments, and it is to be appreciated that various modifications may be made without departing from the gist of the present disclosure.

### EXAMPLE

Next, a result of a highly accelerated life test (HALT) performed on an example will be described below. The example corresponds to the multilayer ceramic capacitor 10 according to an embodiment of the present disclosure, and the dimensions thereof will be presented below. The thickness of each layer was measured using a sectional image captured by a SEM.

Test conditions of HALT testing will be presented below. In the HALT testing, a test for evaluating the effect of adding the Mn element and a test for evaluating the effect of adding the V element were performed. Test conditions of the respective tests are presented below.

### Test Conditions:

### HALT Test for the Mn Element

intra-chamber temperature 125° C., applied voltage 50 V/μm HALT test for the V element
intra-chamber temperature 125° C., applied voltage 30 V/μm Life assessment:

Life is defined as the time (in minutes: median) until the current value exceeds a threshold value.

### Dimensions of Tested Product:

0603(length×width×height=0.6 mm×0.3 mm×0.3 mm)

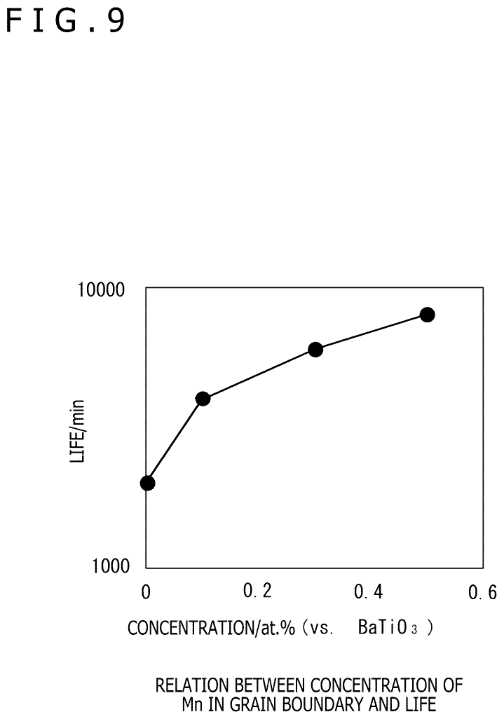

FIG. 9 illustrates a relation between the concentration of the Mn element and the life (in minutes) of the multilayer ceramic capacitor according to the example. It was observed that higher concentrations of the Mn element in the grain boundary 152 lead to a longer life of the multilayer ceramic capacitor.

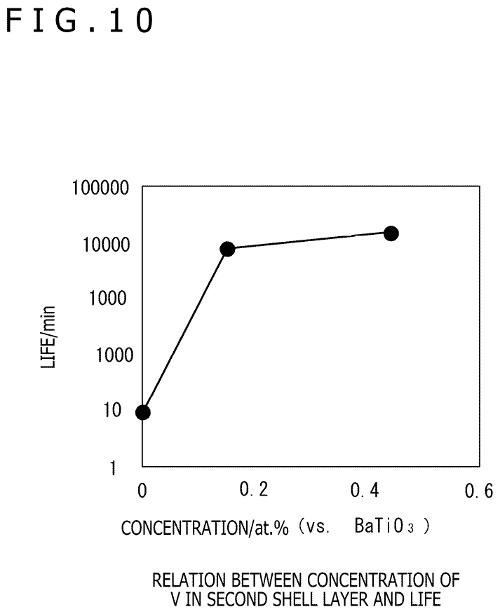

FIG. 10 illustrates a relation between the concentration of the V element and the life (in minutes) of the multilayer ceramic capacitor according to the example. It was observed that higher concentrations of the V element in the second shell layer 151c lead to a longer life of the multilayer ceramic capacitor.

In the foregoing description of an embodiment of the present disclosure, the multilayer ceramic capacitor 10 has been described as an example of a multilayer ceramic electronic component, but it is to be appreciated that the present disclosure is applicable to any of multilayer ceramic electronic components in which dielectric layers and internal electrodes are stacked. Examples of such multilayer ceramic electronic components include a chip varistor, a chip thermistor, and a multilayer inductor.

What is claimed is:

1. A multilayer ceramic electronic component comprising:
an element body including internal electrode layers and dielectric layers stacked alternately, wherein
each of the dielectric layers includes core-shell grains each including a core portion, a first shell layer provided around the core portion, and a second shell layer provided around the first shell layer,
the dielectric layer further includes a grain boundary between adjacent ones of the core-shell grains, and
each of a concentration of a donor element in the first shell layer and a concentration of a donor element in the second shell layer is higher than a concentration of a donor element in the core portion.

2. The multilayer ceramic electronic component according to claim 1, wherein the concentration of the donor element in the second shell layer is higher than the concentration of the donor element in the first shell layer.

3. The multilayer ceramic electronic component according to claim 1, wherein the concentration of the donor element in the second shell layer is in a range of 0.1 to 3.0 at %, inclusive, when that of BaTiO₃ is assumed to be 100 at %.

4. The multilayer ceramic electronic component according to claim 1, wherein the concentration of the donor element in the first shell layer is in a range of 0.01 to 0.5 at %, inclusive, when that of BaTiO₃ is assumed to be 100 at %.

5. The multilayer ceramic electronic component according to claim 1, wherein the second shell layer contains at least one of a V element and an Mo element as the donor element.

6. The multilayer ceramic electronic component according to claim 1, wherein the grain boundary contains an Mn element.

7. The multilayer ceramic electronic component according to claim 6, wherein a concentration of the Mn element in the grain boundary is in a range of 0.05 to 3.0 at %, inclusive, when that of BaTiO₃ is assumed to be 100 at %.

8. The multilayer ceramic electronic component according to claim 1, wherein the core-shell grains are present in the dielectric layer at a ratio ranging from 0.01 to 99 at %, inclusive.

9. The multilayer ceramic electronic component according to claim 1, wherein a thickness of the second shell layer is in a range of 0 nm, exclusive, to 12 nm, inclusive.

10. The multilayer ceramic electronic component according to claim 1, wherein the first shell layer contains a rare-earth element and an Mg element.

11. A method of manufacturing a multilayer ceramic electronic component, the method comprising:
producing raw material powder including core-shell grains each including a core portion, a first shell layer provided around the core portion, and a second shell layer provided around the first shell layer;
producing an element body that is substantially in a shape of a rectangular parallelepiped and that includes first internal electrode layers and second internal electrode layers stacked alternately with dielectric layers each including the raw material powder interposed therebetween; and
subjecting the element body to firing.

12. The method according to claim 11, wherein the producing the raw material powder includes
a first-stage synthesis in which BaTiO₃ grains are coated with a rare-earth element and an Mg element and are subjected to firing,
a second-stage synthesis in which the grains produced by the first-stage synthesis are coated with a donor element and are subjected to firing, and
a third-stage synthesis in which an Mn element is added to the grains produced by the second-stage synthesis.

13. The method according to claim 12, further comprising:
coating the grains produced by the second-stage synthesis with a Yb element.

14. The method according to claim 11, wherein the producing the raw material powder involves addition of at least one of a Si element and a BN compound.

15. The method according to claim 12, wherein the third-stage synthesis involves addition of at least one of a Si element and a BN compound along with the Mn element.

16. The method according to claim 11, wherein, in a case where the producing the raw material powder involves addition of a Si element, an amount of the Si element added is in a range of 0.5 to 3.0 at %, inclusive, when that of BaTiO₃ is assumed to be 100 at %.

17. The method according to claim 11, wherein, in a case where the producing the raw material powder involves addition of a BN compound, an amount of the BN compound added is in a range of 0.1 to 2.0 at %, inclusive, when that of BaTiO₃ is assumed to be 100 at %.

18. The method according to claim 11, wherein the raw material powder contains, as a main component, a ceramic material having a perovskite structure represented by a general formula ABO₃, with A site containing at least Ba, and an A/B ratio being equal to or greater than 1.03 or equal to or smaller than 0.97.

19. The method according to claim 11, wherein the subjecting the element body to firing is subjecting the element body to pressure firing.

20. The method according to claim 19, wherein the pressure firing is performed at a temperature between 1150° C. and 1400° C., inclusive.

21. The method according to claim 19, wherein the pressure firing is performed at a pressure between 1 MPa and 7 MPa, inclusive.
